(19) United States
(12) Patent Application Publication
(10) Pub. No.: US 2026/0288133 A1
(43) Pub. Date: Sep. 24, 2026

(54) VEHICLE CONTROL SYSTEM

(71) Applicant: TOYOTA JIDOSHA KABUSHIKI KAISHA, Toyota-shi (JP)

(72) Inventor: Naofumi KOBAYASHI, Gotemba-shi (JP)

(73) Assignee: TOYOTA JIDOSHA KABUSHIKI KAISHA, Toyota-shi (JP)

(21) Appl. No.: 19/442,087

(22) Filed: Jan. 7, 2026

(30) Foreign Application Priority Data
Mar. 19, 2025 (JP) 2025-045693

(51) Int. Cl. G05D 1/223; G05D 111/50

(52) U.S. Cl. CPC G05D 1/2232; G05D 2111/52

(57) ABSTRACT

A vehicle control system includes a vehicle and a portable terminal. The vehicle includes in-vehicle devices that implement a vehicle function and a control device. The portable terminal is operated by a driver of the vehicle for operating the vehicle function. The portable terminal includes one or more sensors that detect information on an orientation of the portable terminal and an acceleration applied to the portable terminal as sensor information, and a processor. The processor executes operation request specifying processing of specifying an operation request of the driver regarding the vehicle function based on the sensor information, and function control processing of generating a control command in response to the specified operation request and transmitting the generated control command to the vehicle. The control device controls the in-vehicle device corresponding to the vehicle function related to the control command in response to the control command received from the portable terminal.

### CROSS REFERENCE TO RELATED APPLICATION

This application claims priority to Japanese Patent Application No. 2025-045693 filed on Mar. 19, 2025. The disclosure of the above-identified application, including the specification, drawings, and claims, is incorporated by reference herein in its entirety.

### BACKGROUND

### Technical Field

The present disclosure relates to a technology for controlling a vehicle function in response to an operation of a portable terminal by a driver.

### Description of Related Art

Japanese Patent No. 6124841 (JP 6124841 B) discloses a portable device including an acceleration sensor that detects an acceleration along three axes.

In addition, Japanese Patent No. 5955254 (JP 5955254 B) discloses a system that remotely operates a work vehicle using a portable information terminal. The portable information terminal includes a display that displays a driving operation screen that simulates a driving operation region of the work vehicle. A pseudo-operation device (on-screen button incorporated into the driving operation screen) is displayed on the driving operation screen in a disposition corresponding to a disposition of an operation device. An operation input of the pseudo-operation device can be made by designating the on-screen button.

### SUMMARY

A method of using an operation button displayed on a screen of a portable terminal for operating a vehicle function using the portable terminal by a driver of a vehicle (for example, an automobile) (for example, refer to JP 5955254 B) is known. However, with this method, visual confirmation of a touch position on the screen by the driver is needed. In addition, as the number of vehicle functions to be operated increases, the number of operation buttons on the screen increases. As a result, complicated display on the screen may be caused or the driver may focus on the screen during vehicle driving.

The present disclosure has been made in view of the problem, and an object of the present disclosure is to provide a vehicle control system in which a driver can operate a vehicle function using a portable terminal without focusing on a screen of the portable terminal.

A vehicle control system according to the present disclosure includes a vehicle and a portable terminal. The vehicle includes a plurality of in-vehicle devices configured to implement a vehicle function and a control device. The portable terminal is operated by a driver of the vehicle for operating the vehicle function. The portable terminal includes one or more sensors configured to detect information on an orientation of the portable terminal and an acceleration applied to the portable terminal as sensor information, and a processor. The processor is configured to execute operation request specifying processing of specifying an operation request of the driver regarding the vehicle function based on the sensor information, and function control processing of generating a control command in response to the specified operation request and transmitting the generated control command to the vehicle. The control device is configured to control an in-vehicle device corresponding to the vehicle function related to the control command in response to the control command received from the portable terminal.

According to the present disclosure, the vehicle function can be operated by the driver performing an action, such as changing the orientation of the portable terminal or knocking the portable terminal. Therefore, the driver can operate the vehicle function using the portable terminal without focusing on the screen of the portable terminal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing an example of a configuration of a vehicle control system according to the embodiment;

FIG. 2 is a diagram showing an example of a functional block related to control of a plurality of vehicle functions using the portable terminal according to the embodiment;

FIG. 3A is a diagram for describing a correspondence relationship between an operation of the portable terminal during a horizontal holding and an actuation of the vehicle function;

FIG. 3B is a diagram for describing a correspondence relationship between an operation of the portable terminal during a horizontal holding and an actuation of the vehicle function;

FIG. 4A is a diagram for describing a correspondence relationship between an operation of the portable terminal during a vertical holding and an actuation of the vehicle function;

FIG. 4B is a diagram for describing a correspondence relationship between an operation of the portable terminal during a vertical holding and an actuation of the vehicle function;

FIG. 5A is a diagram for supplementarily describing details of a filter processing unit shown in FIG. 2;

FIG. 5B is a diagram for supplementarily describing details of an operation determination unit shown in FIG. 2;

FIG. 5C is a diagram for supplementarily describing details of the operation determination unit shown in FIG. 2; and

FIG. 6 is a diagram for supplementarily describing details of the operation determination unit shown in FIG. 2.

### DETAILED DESCRIPTION OF EMBODIMENTS

Embodiments of the present disclosure will be described with reference to the accompanying drawings.

### Configuration of Vehicle Control System

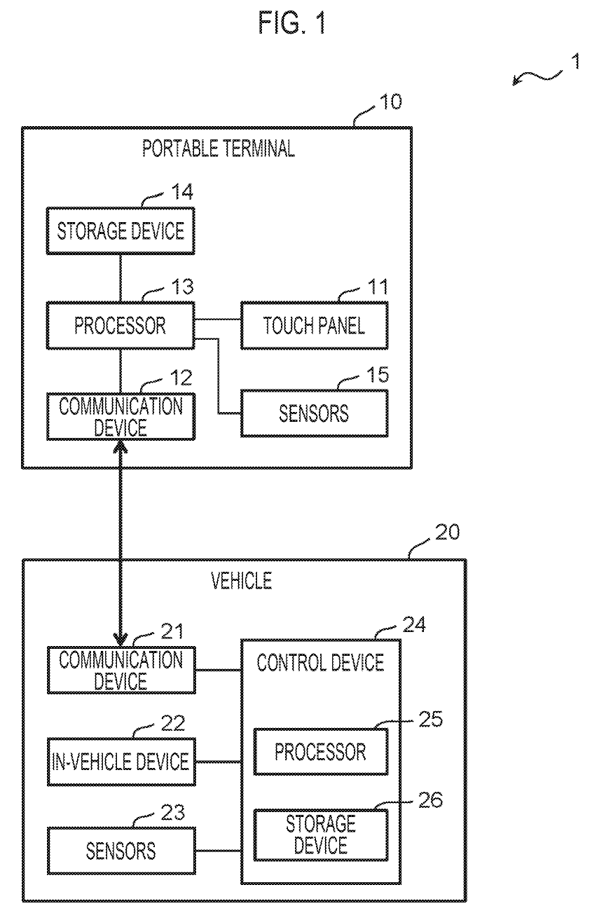

FIG. 1 is a schematic diagram showing an example of a configuration of a vehicle control system 1 according to the present embodiment. The vehicle control system 1 includes a portable terminal 10 and a vehicle 20. The vehicle 20 is, for example, an automobile. The portable terminal 10 is operated by the driver for operating a plurality of vehicle functions Fv of the vehicle 20.

The portable terminal 10 communicates with the vehicle 20. In the present embodiment, the driver rides in the vehicle 20 and operates the vehicle function Fv using the portable terminal 10 that communicates with the vehicle 20 wirelessly or via a wired connection. However, the driver does not always have to ride in the vehicle 20 in a case of operating the vehicle function Fv, and the vehicle function Fv may be operated using the portable terminal 10 that communicates with the vehicle 20 wirelessly outside the vehicle 20.

The vehicle function Fv includes a basic vehicle function Fv1 related to vehicle traveling, such as running, turning, and stopping. That is, the driver operates the vehicle 20 (drives the vehicle 20) related to the traveling of the vehicle 20 using the portable terminal 10. In addition, the vehicle function Fv includes an auxiliary or additional vehicle function Fv2. Examples of the vehicle function Fv2 include blinking/turning off of a turn signal, blinking/turning off of a hazard lamp, switching of a shift range, sounding/stopping of a horn, blinking/turning off of a headlight, operation/stop of an air conditioner, and operation/stop of a wiper.

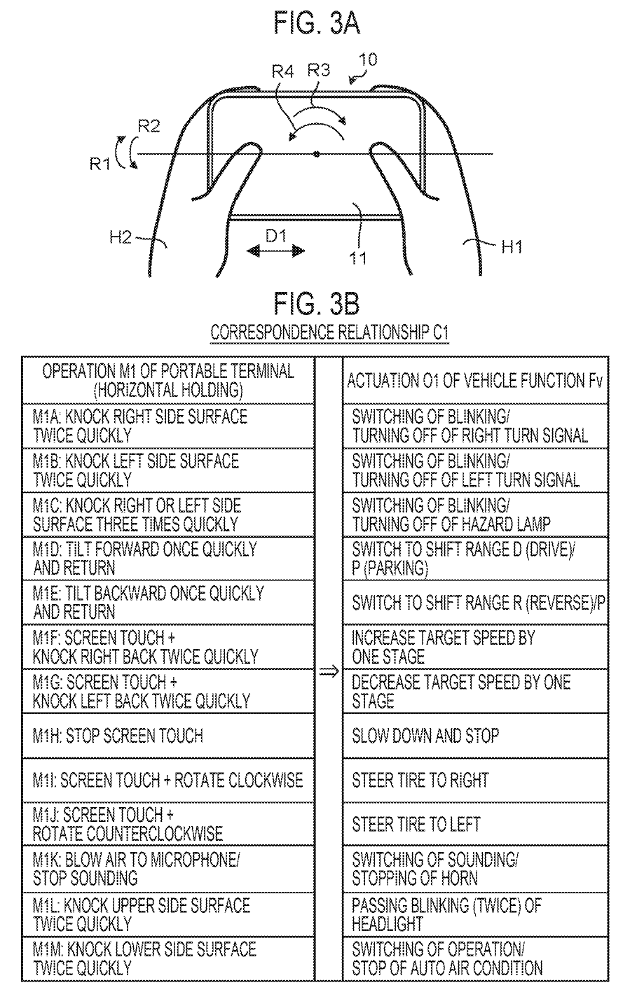

The portable terminal 10 is, for example, a portable terminal, such as a smartphone or a tablet terminal. The portable terminal 10 includes, for example, a touch panel 11, a communication device 12, a processor 13, a storage device 14, and sensors 15. The touch panel 11 is provided on one surface of the portable terminal 10 and includes a display screen and a touch sensor included in the sensors 15. The touch sensor is configured to detect a touch of the driver on the display screen. The communication device 12 communicates with the vehicle 20. A shape of the portable terminal 10 is not particularly limited, but the portable terminal 10 is provided in a plate shape (for example, a rectangular plate shape) in which one side is a short direction and the other side is a long direction (see FIGS. 3A and 3B).

The processor (processing circuit) 13 executes various types of processing for operating the vehicle functions Fv using the portable terminal 10. Examples of the processor 13 include a general-purpose processor and a specific-purpose processor. In addition, examples of the processor 13 include a central processing unit (CPU), a graphics processing unit (GPU), and an application specific integrated circuit (ASIC). Further, examples of the processor 13 include a field-programmable gate array (FPGA). The storage device 14 stores various types of information needed for the processing by the processor 13. Examples of the storage device 14 include a volatile memory, a non-volatile memory, a hard disk drive (HDD), and a solid state drive (SSD). The processor 13 executes a computer program. The computer program is stored in the storage device 14. Alternatively, the computer program may be recorded in a computer-readable recording medium or may be provided via a network.

The sensors 15 include a sensor for detecting information on the orientation of the portable terminal 10 (more specifically, a tilt direction and a tilt angle of the portable terminal 10) and an acceleration applied to the portable terminal 10. The sensor is configured to include, for example, an acceleration sensor and a gyro sensor, and is, for example, a six-axis motion sensor in which a three-axis acceleration sensor and a three-axis gyro sensor are combined. The information on the orientation and the acceleration detected by the sensor (orientation information Isp and acceleration information Isa) corresponds to "sensor information Is" according to the present disclosure.

In addition, the sensors 15 may include, for example, at least one of a microphone or an image sensor (camera). That is, the sensor information Is may include information (sound information Iss) of the microphone and information (image information Isi) of the image sensor. Further, the sensor information Is may include information (screen touch information Ist) indicating whether the screen is touched by the touch sensor. The sensors 15 correspond to an example of "one or more sensors" according to the present disclosure.

The vehicle 20 includes a communication device 21, a plurality of in-vehicle devices 22, sensors 23, and a control device 24. The communication device 21 communicates with the portable terminal 10. The in-vehicle devices 22 are devices for implementing the vehicle functions Fv. Specifically, the in-vehicle devices 22 include a traveling device for implementing the basic vehicle function Fv1 related to the vehicle traveling. The traveling device includes a drive device, a steering device, and a braking device. The drive device includes one or both of an electric motor and an internal combustion engine for driving the vehicle 20. The steering device includes an electric motor that turns the wheels. The braking device includes a brake actuator for braking the vehicle 20. In addition, the in-vehicle devices 22 include various devices for implementing the auxiliary or additional vehicle function Fv2. Examples of the various devices include a light device (turn signal, hazard lamp), a shift device (device for switching the shift range), a horn device, a headlight device, an air conditioner device, and a wiper device.

The sensors 23 include, for example, a recognition sensor, a vehicle state sensor, and a position sensor. The recognition sensor (for example, a camera and a radar) recognizes a situation around the vehicle 20. The vehicle state sensor (for example, a speed sensor, an acceleration sensor, a yaw rate sensor, a steering angle sensor) detects a state of the vehicle 20. The position sensor (for example, a global navigation satellite system (GNSS) receiver) detects a position and an orientation of the vehicle 20.

The control device 24 is a computer that controls the vehicle functions Fv. The control device 24 includes one or more processors 25 (hereinafter, simply referred to as a processor 25) and one or more storage devices 26 (hereinafter, simply referred to as a storage device 26). The processor 25 executes various types of processing related to the control of the vehicle functions Fv. The storage device 26 stores various types of information needed for the processing by the processor 25. A configuration example of the processor 25 is the same as that of the processor 13 described above. In addition, a configuration example of the storage device 26 is the same as that of the storage device 14 described above.

### Control of Plurality of Vehicle Functions Using Portable Terminal

The driver uses the portable terminal 10 to operate the vehicle functions Fv. The portable terminal 10 generates a control command INS in response to the operation of the portable terminal 10 by the driver, and transmits the generated control command INS to the vehicle 20. The vehicle 20 controls the in-vehicle device 22 in response to the received control command INS. As a result, the control of the vehicle functions Fv using the portable terminal 10 is realized.

Here, it is considered to use an operation button displayed on a screen of the portable terminal for the driver to operate the vehicle function Fv using the portable terminal 10. However, with this method, visual confirmation of a touch position on the screen by the driver is needed. In addition, as the number of vehicle functions Fv to be operated increases, the number of operation buttons on the screen increases. As a result, complicated display on the screen may be caused or the driver may focus on the screen during vehicle driving.

Therefore, in the present embodiment, the portable terminal 10 (processor 13) executes "operation request specifying processing" and "function control processing". In the operation request specifying processing, the portable terminal 10 specifies an operation request Rm of the driver regarding the vehicle function Fv based on the sensor information Is. In the function control processing, the portable terminal 10 generates the control command INS in response to the specified operation request Rm, and transmits the generated control command INS to the vehicle 20. The control device 24 (processor 25) of the vehicle 20 controls the in-vehicle device 22 corresponding to the vehicle function Fv related to the control command INS in response to the received control command INS.

### Functional Block

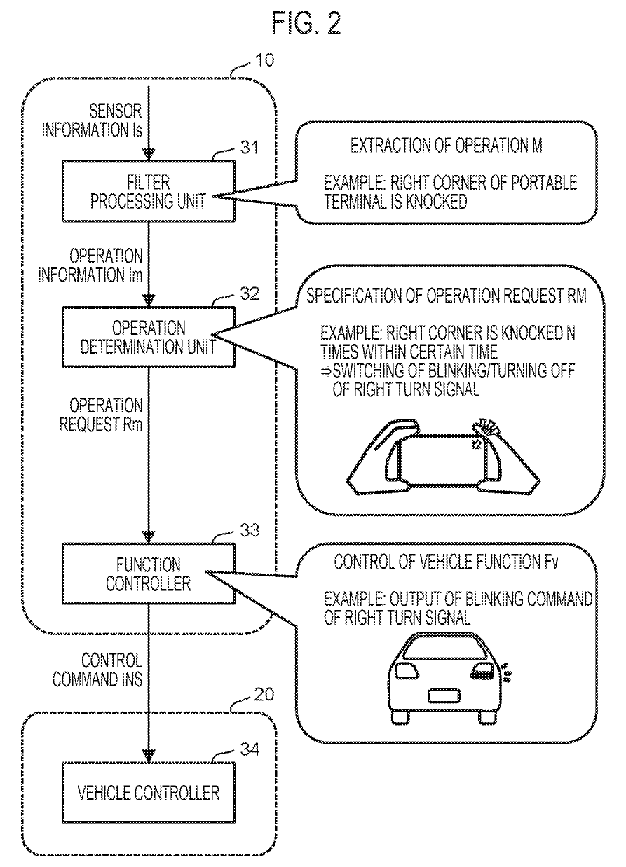

FIG. 2 is a diagram showing an example of a functional block related to the control of the vehicle functions Fv using the portable terminal 10 according to the present embodiment. As the functional block, the portable terminal 10 includes a filter processing unit 31, an operation determination unit 32, and a function controller 33. The control device 24 of the vehicle 20 includes a vehicle controller 34. These functional blocks are implemented by software at the time when a program related to the present control is executed by the processor 13 or 25.

### Summary

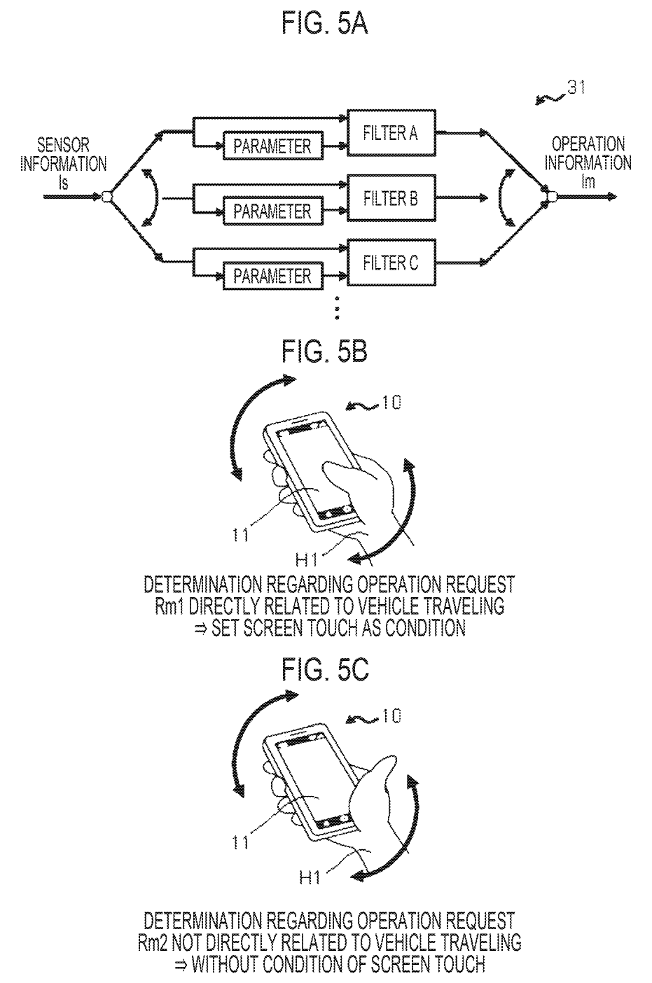

The processing of the filter processing unit 31 and the operation determination unit 32 corresponds to the "operation request specifying processing". The sensor information Is (for example, the orientation information Isp and the acceleration information Isa) is input to the filter processing unit 31. The filter processing unit 31 extracts operation information Im (that is, information on an operation M intended by the driver for operating the vehicle function Fv) of the driver related to the vehicle function Fv from the sensor information Is. More specifically, the operation information Im is different from a change in the sensor information Is caused by gripping the portable terminal 10 or moving the driver (holder), or the like. The operation information Im is obtained by observing an obvious motion of the portable terminal 10 caused by the actuation of the driver via the sensors 15. An example of the operation information Im is "right corner of the portable terminal 10 is knocked". The extracted operation information Im is output to the operation determination unit 32. A method of extracting the operation information Im will be described later with reference to FIG. 5A.

The operation determination unit 32 determines the operation M intended by the driver based on the extracted operation information Im. For example, it is assumed that the operation information Im indicating that "the right corner of the portable terminal 10 is knocked" is extracted N times (N: predetermined value) within a predetermined time by the filter processing unit 31. In this case, the operation determination unit 32 determines (specifies) that the operation request Rm of the driver is "switching of blinking/turning off of the right turn signal". A method of determining the operation request Rm will be described later with reference to FIGS. 5B and 5C.

The storage device 14 of the portable terminal 10 stores a correspondence relationship C between the "operation M of the portable terminal 10" by the driver and an "actuation O of the vehicle function Fv" as a database.

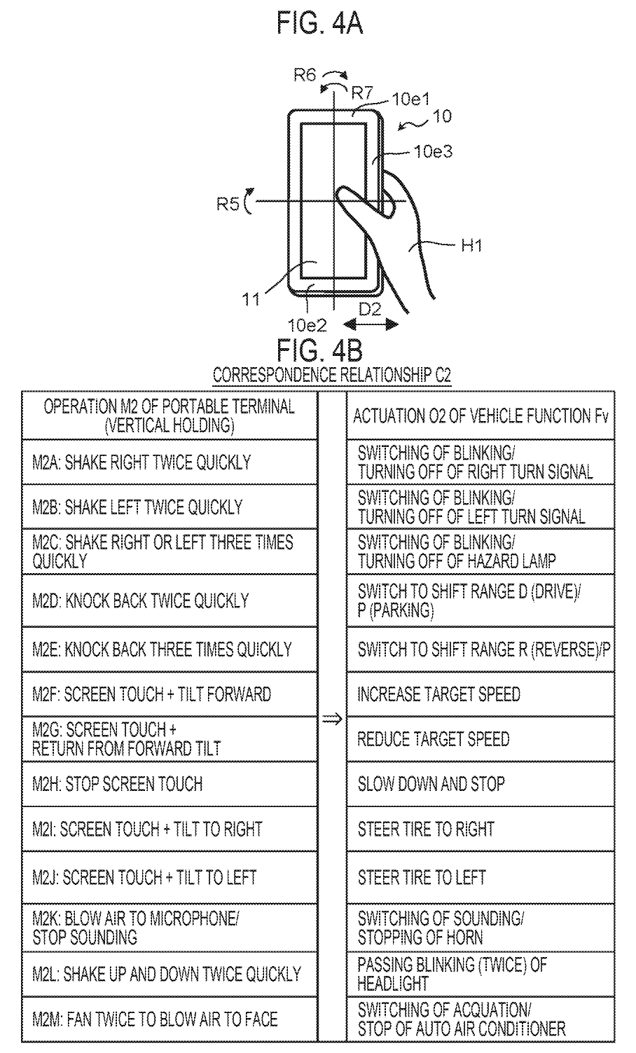

FIGS. 3A and 3B are diagrams showing an example of a correspondence relationship C1 between an operation M1 of the portable terminal 10 during a horizontal holding and an actuation O1 of the vehicle function Fv. FIGS. 4A and 4B are diagrams showing an example of a correspondence relationship C2 between an operation M2 of the portable terminal 10 during a vertical holding and an actuation O2 of the vehicle function Fv. The driver has previously learned such a correspondence relationship C1 and C2.

A way of holding the portable terminal 10 in a case where the driver operates the vehicle functions Fv may be selectable between "horizontal holding" and "vertical holding". As shown in FIG. 3A, the horizontal holding corresponds to a holding method in which both ends 10e1 and 10e2 (see FIG. 4A) of the portable terminal 10 in the longitudinal direction D1 are held by both hands H1 and H2. On the other hand, as shown in FIG. 4A, the vertical holding corresponds to a holding method in which one end 10e3 of the portable terminal 10 in the short direction D2 is held by one hand (for example, H1) of the operator. For example, the driver operates the portable terminal 10 to select one of the horizontal holding or the vertical holding before starting driving of the vehicle 20. In this case, the driver selects, for example, one of a horizontal holding selection button and a vertical holding selection button displayed on the touch panel 11.

In a case where the horizontal holding is selected by the driver, the processor 13 uses the correspondence relationship C1 shown in FIG. 3B. Specifically, the filter processing unit 31 extracts the operation information Im related to the operation M1 of the portable terminal 10 included in the correspondence relationship C1 from various types of sensor information Is. FIG. 3B shows examples of operations M1A to M1M that are specific examples of the operation M1. The operations M1A to M1C and M1L, M1M can be extracted from the acceleration information Isa. The operations M1D, M1E can be extracted from the orientation information Isp. The operations M1F, M1G can be extracted from the acceleration information Isa and the screen touch information Ist. The operation M1H can be extracted from the screen touch information Ist. The operations M1I, M1J can be extracted from the orientation information Isp and the screen touch information Ist. The operation M1K can be extracted from the sound information Iss. The operation determination unit 32 determines (specifies) the operation request Rm of the driver (in other words, the actuation O1 of the vehicle function Fv desired by the driver) based on the extracted operation information Im and the correspondence relationship C1.

The contents of each specific example of the operation M1 and the actuation O1 are as described in FIG. 3B, and the repeated description thereof will be omitted here. However, the contents of each specific example will be described as follows. Each of the "right-left" and "up-down" in each operation M1 corresponds to the right-left and up-down of the paper surface of FIG. 3A. The "right side surface" of the portable terminal 10 in the operation M1A may include the "right corner" as in the example shown in FIG. 2 (the same applies to the "left side surface" in the operation M1B). The "forward tilt" in the operation M1D corresponds to tilting the portable terminal 10 in the rotation direction R1 in FIG. 3A, and the "backward tilt" in the operation M1E corresponds to tilting the portable terminal 10 in the rotation direction R2. The "right back" in the operation M1F corresponds to a portion on the right side of the paper surface on a surface (back surface) opposite to a front surface of the portable terminal 10 on which the touch panel 11 is provided (the same applies to the "left back" in the operation M1G). The "clockwise" in the operation M1I corresponds to the rotation direction R3 in FIG. 3A, and the "counterclockwise" in the operation M1J corresponds to the rotation direction R4.

At the time when the vertical holding is selected by the driver, the processor 13 uses the correspondence relationship C2 shown in FIG. 4B. Specifically, the filter processing unit 31 extracts the operation information Im related to the operation M2 of the portable terminal 10 included in the correspondence relationship C2. FIG. 4B shows examples of operations M2A to M2M that are specific examples of the operation M2. The operations M2A to M2E and M2L can be extracted from the acceleration information Isa. The operations M2F, M2G and M2I, M2J can be extracted from the orientation information Isp and the screen touch information Ist. The operation M2H can be extracted from the screen touch information Ist. The operation M2K can be extracted from the sound information Iss. The operation M2M can be extracted based on, for example, the image information Isi together with the acceleration information Isa and the orientation information Isp. The operation determination unit 32 determines (specifies) the operation request Rm of the driver (in other words, the actuation O2 of the vehicle function Fv desired by the driver) based on the extracted operation information Im and the correspondence relationship C2.

The contents of each specific example of the operation M2 and the actuation O2 are as described in FIG. 4B, and the repeated description thereof will be omitted here. However, the contents of each specific example will be described as follows. Each of the "right-left" and "up-down" in each operation M2 corresponds to the right-left and up-down of the paper surface of FIG. 4A. The "back" in the operations M2D and M2E corresponds to a portion on the surface (back surface) opposite to the front surface of the portable terminal 10 on which the touch panel 11 is provided. The "forward tilt" in the operations M2F and M2G corresponds to tilting the portable terminal 10 in the rotation direction R5 in FIG. 4A. The "tilt to the right" in the operation M2I corresponds to tilting the portable terminal 10 in the rotation direction R6 in FIG. 4A, and the "tilt to the left" in the operation M2J corresponds to tilting the portable terminal 10 in the rotation direction R7.

It is assumed that the driver does not intend the operation M1 and M2 but drops the portable terminal 10. As a result, it is assumed that the sensor information Is (the acceleration information Isa and/or the orientation information Isp) indicating that the portable terminal 10 receives a strong impact or rotates violently is received. In this case, the processor 13 may execute processing of stopping the control of the vehicle function Fv using the portable terminal 10.

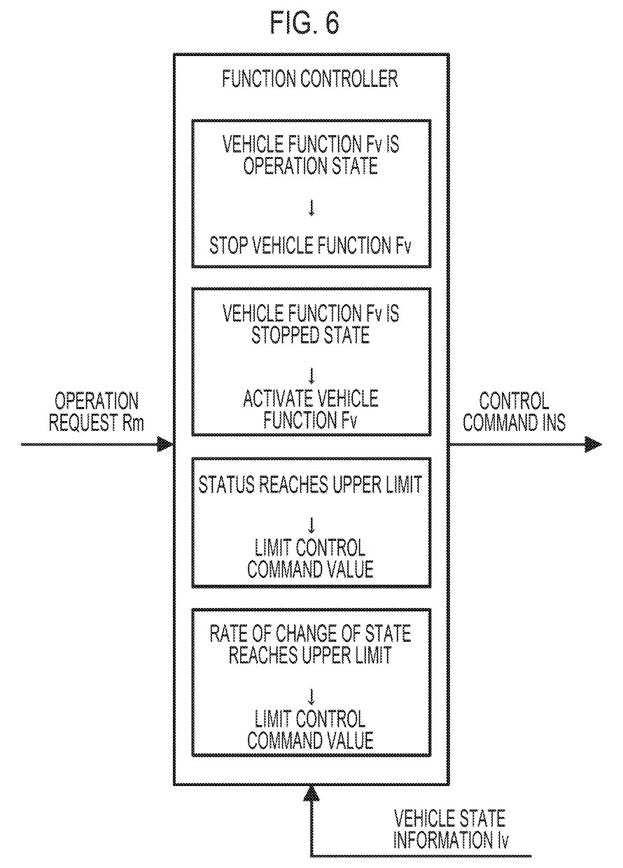

In FIG. 2, the operation request Rm from the operation determination unit 32 is input to the function controller 33. The processing of the function controller 33 corresponds to the "function control processing". The function controller 33 generates the control command INS (for example, a blinking command of the right turn signal) in response to the specified operation request Rm. The function controller 33 transmits the generated control command INS to the vehicle 20. A method of generating the control command INS will be described later with reference to FIG. 6.

The control command INS from the function controller 33 is input to the vehicle controller 34 on the vehicle 20 side. The vehicle controller 34 controls the in-vehicle device 22 corresponding to the related vehicle function Fv in response to the received control command INS. For example, in a case where the control command INS is the blinking command of the right turn signal, the vehicle controller 34 controls the turn signal device such that the right turn signal blinks.

### Details

FIG. 5A is a diagram for supplementarily describing details of the filter processing unit 31 shown in FIG. 2. As described above, the filter processing unit 31 extracts the operation information Im of the driver from various types of sensor information Is. For example, the filter processing unit 31 selectively or in combination uses a plurality of filters A to C for extracting the operation information Im. Examples of the filters include a frequency-dependent filter, such as a low-pass filter or a band-pass filter, and a neural network model generated by machine learning. Various parameters of each filter are input to each of the filters together with the sensor information Is. The filter processing unit 31 may be configured to switch at least one of a type of the filter to be used or a parameter thereof according to a type (the acceleration information Isa, the orientation information Isp, the sound information Iss, and the like) of the input sensor information Is. In addition, in an example in which the driver rides in the vehicle 20 and operates the portable terminal 10, at least one of the filters may be configured to have a function of separating an influence of the motion of the vehicle 20 on the sensor information Is. The determination of the driver's boarding by the portable terminal 10 can be performed, for example, by using a seat sensor or a seat belt wearing sensor mounted in the vehicle 20, or by using a determination result of the connection of the portable terminal 10 to the device mounted in the vehicle 20.

FIGS. 5B and 5C are diagrams for supplementarily describing details of the operation determination unit 32 shown in FIG. 2. As described above, the operation determination unit 32 determines the operation M intended by the driver (that is, specifies the operation request Rm) based on the extracted operation information Im. The operation request Rm of the driver may include operation requests Rm1 and Rm2. The operation request Rm1 corresponds to an operation request directly related to the vehicle traveling, such as running, turning, and stopping (that is, the operation request regarding the basic vehicle function Fv1). For example, the operation request Rm1 corresponds to the operations M1F, M1G and M1I, M1J in FIG. 3B and the operations M2F, M2G and M2I, M2J in FIG. 4B. The operation request Rm2 corresponds to an operation request that is not directly related to the vehicle traveling (that is, the operation request regarding the auxiliary or additional vehicle function Fv2).

The operation determination unit 32 specifying the operation request Rm based on the extracted operation information Im may include, as shown in FIG. 5B, a condition that the operation information Im is extracted together with the touch of the display screen by the driver. In this case, the operation determination unit 32 may include determining whether the operation request Rm1 (first operation request) is present. The operation determination unit 32 specifying the operation request Rm may include determining whether the operation request Rm2 (second operation request) is present without the condition that the operation information Im is extracted together with the touch of the display screen as shown in FIG. 5C.

FIG. 6 is a diagram for supplementarily describing details of the operation determination unit 32 shown in FIG. 2. As described above, the function controller 33 generates the control command INS in response to the specified operation request Rm. More specifically, as shown in FIG. 6, the vehicle state information Iv may be input to the function controller 33 together with the operation request Rm. The vehicle state information Iv is information indicating a current control state of the vehicle function Fv related to the input operation request Rm. The portable terminal 10 (processor 13) communicates with the vehicle 20 and acquires the vehicle state information Iv related to the input operation request Rm (for example, switching of blinking/turning off of the right turn signal) from the vehicle 20.

As shown in FIG. 6, the vehicle state information Iv is, for example, "the vehicle function Fv is in an operation state". In this example, the function controller 33 generates the control command INS (for example, a turn-off command of the right turn signal) for stopping the vehicle function Fv.

In another example, the vehicle state information Iv is "the vehicle function Fv is in a stop state". In this example, the function controller 33 generates the control command INS (for example, a blinking command of the right turn signal) for operating the vehicle function Fv.

In still another example, the vehicle state information Iv is "the control state of the vehicle function Fv has reached an upper limit (for example, the speed or the steering angle of the vehicle 20 has reached the upper limit)". In this example, the function controller 33 limits the control command value (for example, the target speed and the target steering angle) such that the upper limit is not exceeded.

In still another example, the vehicle state information Iv is "the change rate of the control state of the vehicle function Fv has reached an upper limit (for example, the change rate of the speed or the steering angle of the vehicle 20 has reached the upper limit)". In this example, the function controller 33 limits the control command value (for example, the target speed and the target steering angle) such that the upper limit of the change rate is not exceeded.

As described above, the function controller 33 may generate the control command INS for the in-vehicle device 22 related to the operation request Rm in consideration of the current control state of the vehicle function Fv related to the operation request Rm together with the operation request Rm.

### Effects

As described above, according to the present embodiment, the vehicle function Fv can be operated by the driver performing an action, such as changing the orientation of the portable terminal 10 or knocking the portable terminal 10. Therefore, the driver can operate the vehicle function Fv using the portable terminal 10 without focusing on the screen of the portable terminal 10.

In addition, as described above, the operation determination unit 32 specifying the operation request Rm may include determining whether the operation request Rm1 directly related to the vehicle traveling is present, on a condition that the operation information Im is extracted with the screen touch. Further, the operation determination unit 32 may include determining whether the operation request Rm2 that is not directly related to the vehicle traveling is present, without the condition that the operation information Im is extracted with the screen touch (refer to FIGS. 5B and 5C). By using the screen touch information Ist in combination with the acceleration information Isa or the orientation information Isp in this way, it is possible to appropriately suppress the erroneous operation of the vehicle function Fv.

In addition, as described above, the function controller 33 may generate the control command INS in consideration of the vehicle state information Iv (the current control state of the vehicle function Fv) together with the operation request Rm (see FIG. 6). As a result, it is possible to appropriately generate the control command INS.

What is claimed is:

1. A vehicle control system comprising:
a vehicle including a plurality of in-vehicle devices configured to implement a vehicle function and a control device; and
a portable terminal operated by a driver of the vehicle for operating the vehicle function, wherein:
the portable terminal includes
one or more sensors configured to detect information on an orientation of the portable terminal and an acceleration applied to the portable terminal as sensor information, and
a processor;
the processor is configured to execute
operation request specifying processing of specifying an operation request of the driver regarding the vehicle function based on the sensor information, and
function control processing of generating a control command in response to the specified operation request and transmitting the generated control command to the vehicle; and
the control device is configured to control an in-vehicle device corresponding to the vehicle function related to the control command in response to the control command received from the portable terminal.

2. The vehicle control system according to claim 1, wherein in the operation request specifying processing, the processor is configured to
extract operation information of the driver related to the vehicle function from the sensor information, and
specify the operation request based on the extracted operation information.

3. The vehicle control system according to claim 2, wherein:
the one or more sensors include a touch sensor configured to detect a touch of the driver on a display screen of the portable terminal; and
in the operation request specifying processing, specifying the operation request based on the extracted operation information includes
determining whether a first operation request directly related to traveling of the vehicle is present, on a condition that the operation information is extracted together with the touch of the display screen by the driver, and
determining whether a second operation request not directly related to the traveling of the vehicle is present, without the condition that the operation information is extracted together with the touch.

4. The vehicle control system according to claim 1, wherein, in the function control processing, the processor is configured to generate the control command for the in-vehicle device related to the operation request based on the operation request and a current control state of the vehicle function related to the operation request.
